(19) United States
(12) Patent Application Publication
(10) Pub. No.: US 2025/0187884 A1
(43) Pub. Date: Jun. 12, 2025

(54) CONTINUOUS AND DISCRETE ESTIMATION OF PAYLOAD ENGAGEMENT/DISENGAGEMENT SENSING

(71) Applicant: Seegrid Corporation, Pittsburgh, PA (US)

(72) Inventors: Nathan Greco, Beaver, PA (US); Adam Grusky, PIttsburgh, PA (US); David Deutsch, Evans City, PA (US)

(21) Appl. No.: 18/846,359

(22) PCT Filed: Mar. 28, 2023
(86) PCT No.: PCT/US2023/016615

§ 371 Date: Sep. 12, 2024

Related U.S. Application Data
(60) Provisional application No. 63/324,188, filed on Mar. 28, 2022.

(51) Int. Cl. B66F 9/06; B66F 9/075; B66F 9/24

(52) U.S. Cl. CPC B66F 9/063; B66F 9/0755; B66F 9/24

(57) ABSTRACT

In accordance with one aspect of the inventive concepts, provided is an autonomous mobile robot, comprising: at least one processor in communication with at least one computer memory device; at least one sensor positioned on the robot to acquire data indicating a position of a payload along fork tines of the robot, the data comprising at least one of discrete and continuous measurements; and a payload monitoring system comprising computer program code executable by the at least one processor to monitor one of pushing and dragging of the payload based on the data. A corresponding method is also provided.

### CROSS REFERENCE TO RELATED APPLICATIONS

This application claims priority to a provisional application entitled Continuous and Discrete Estimation of Payload Engagement Disengagement Sensing and having provisional application No. 63/324,188 filed Mar. 28, 2022, which is hereby incorporated by reference in its entirety.

The present application may be related to U.S. Provisional Appl. 63/430,184filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; U.S. Provisional Appl. 63/346,483 filed on May 27, 2022, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to US Provisional Appl. 63/324, 182filed on Mar. 28, 2022, entitled A Hybrid, Context-Aware Localization System For Ground Vehicles; U.S. Provisional Appl. 63/324,184 filed on Mar. 28, 2022, entitled Safety Field Switching Based On End Effector Conditions; US Provisional Appl. 63/324, 185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,190 filed on Mar. 28, 2022, entitled Passively Actuated Sensor Deployment; US Provisional Appl. 63/324, 192 filed on Mar. 28, 2022, entitled Automated Identification Of Potential Obstructions In A Targeted Drop Zone; U.S. Provisional Appl. 63/324, 193 filed on Mar. 28, 2022, entitled Localization Of Horizontal Infrastructure Using Point Clouds; U.S. Provisional Appl. 63/324,195 filed Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object; and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on April 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No 9,910, 137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design Patent Appl. 29/398,127, filed on Jul. 26, 2011, U.S. Pat. No. D680,142, Issued on Apr. 16, 2013, entitled Multi-Camera Head; U.S. Design patent application Ser. No. 29/471,328, filed on Oct. 30, 2013, U.S. Patent Number D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to the field of systems and methods in the field of autonomous and/or robotic vehicles. Aspects of the inventive concepts are applicable to any mobile robotics application. More specifically, the present inventive concepts relate to systems and methods of continuous and discrete estimation of payload engagement/disengagement sensing.

### BACKGROUND

In autonomous forklifts constructed with autonomous mobile robot (AMR) technology, it is desirable to know the position of the payload with respect to the location of the forks. This is important to verify that the payload is being engaged/disengaged properly (i.e., the payload is not being pushed during attempted engagement or dragged during attempted disengagement). This helps prevent the AMR from dropping payloads, pushing payloads, or maneuvering while payloads are not fully loaded.

Conventional AMRs can use an electronic sensor to locate an opening in the pallet of interest prior to engagement or disengagement by the AMR's forks, or more specifically, the tines or prongs of the forks. However, the sensor cannot be used during engagement and/or disengagement because the sensor's view is blocked by the payload.

Previous payloads have always been located on the floor and pushing or dragging did not cause a problem. In current designs, full engagement of the payload is detected with a single, paddle switch but the paddle switch does not provide information whether pushing or dragging is occurring as the AMR forks extend through the pallet. Now that AMRs are interacting with payloads at various heights since the forks can move vertically, pushing or dragging a payload that could cause the payload to fall from a height could have disastrous consequences.

### SUMMARY OF THE INVENTION

In accordance with one aspect of the inventive concepts, provided is an autonomous mobile robot, comprising: at least one processor in communication with at least one computer memory device and a payload monitoring system. The payload monitoring system comprises at least one carriage sensor positioned on the robot to acquire position data indicating a position of a payload relative to fork tines of the robot; and a computer program code executable by the at least one processor to process the position data to determine if the payload is being properly engaged or disengaged and is consistent with our planned motion. This can prevent cases of pushing, dragging, absence, or other undesirable conditions when engaging a load.

In various embodiments, the payload monitoring system is configured to provide continuous estimation of the payload position relative to fork tines of the autonomous mobile robot and/or provide a set of discrete outputs at specified distances along the fork tines to determine the location of the payload relative to the fork tines.

In various embodiments, the payload monitoring system is configured to determine if the payload is being picked up or dropped off based on the position data.

In various embodiments, the payload monitoring system is configured to generate a signal for use by a drive system of the robot to stop, pause, or alter navigation based on the determination of the payload being pushed or dragged.

In various embodiments, the at least one carriage sensor comprises 2D LiDAR sensor that has PLd field occlusion detection and raw data output.

In various embodiments, the at least one carriage sensor comprises a laser scanner.

In various embodiments, the robot comprises a load backrest and the payload monitoring system is configured to parse raw data relative to a nearest point of the payload and to the load backrest.

In various embodiments, the at least one carriage sensor is configured to monitor a leading edge of a payload along the fork tines.

In various embodiments, the at least one carriage sensor is positioned to have a line of sight with the fork tines of the robot.

In various embodiments, the fork tines are at an elevation and along a reach axis, and the at least one carriage sensor acquires position data indicating a position of a payload relative to the fork tines along the reach axis.

In accordance with another aspect of the inventive concepts, provided is a method of monitoring a payload on a mobile robot, comprising: at least one sensor acquiring position data indicating a position of a payload relative to fork tines of the robot; and processing the position data to determine if the payload is being pushed or dragged based on a presence or an absence of the payload at the multiple locations of the fork tines.

In various embodiments, the method includes providing continuous estimation of the payload position relative to the fork tines and/or providing a set of discrete outputs at specified distances along the forks to determine the location of the payload relative to the fork tines.

In various embodiments, the method includes determining if the payload is being picked up or dropped off based on the position data.

In various embodiments, the method includes generating a signal for use by a drive system of the robot to stop, pause, or alter navigation based on the determination of the payload being pushed or dragged.

In various embodiments, the at least one sensor comprises a 2D LiDAR sensor that has PLd field occlusion detection and raw data output.

In various embodiments, the at least one carriage sensor comprises a laser scanner.

In various embodiments, the robot comprises a backrest and the method includes parsing raw data relative to a nearest point of the payload and to the backrest.

In various embodiments, the method includes the at least one carriage sensor monitoring a leading edge of a payload relative to the fork tines.

In various embodiments, the at least one carriage sensor is positioned to have a line of sight with the fork tines.

In various embodiments, the fork tines are at an elevation and along a reach axis, and the at least one carriage sensor acquires position data indicating a position of a payload relative to the fork tines along the reach axis.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1A provides a perspective view of a robotic vehicle in accordance with aspects of the inventive concepts.

FIG. 1B provides a side view of a robotic vehicle with its load engagement portion retracted, in accordance with aspects of the inventive concepts.

FIG. 1C provides a side view of a robotic vehicle with its load engagement portion extended, in accordance with aspects of the inventive concepts.

FIG. 2 is a block diagram of an embodiment of an AMR, in accordance with aspects of the inventive concepts.

FIG. 3 is a diagram of an embodiment of an AMR having at least one carriage sensor and locations that the at least one carriage sensor can detect, in accordance with aspects of the inventive concepts.

FIG. 3A provides a side view of an AMR with its load engagement portion retracted and at a ground level and including indicators of locations that the at least one carriage sensor can detect, in accordance with aspects of the inventive concepts.

FIG. 3B provides a side view of an AMR with its load engagement portion raised and extended and including indicators of locations that the at least one carriage sensor can detect, in accordance with aspects of the inventive concepts.

FIG. 4 is a flow diagram of an embodiment of a method for monitoring an engagement of a payload by an AMR forklift, in accordance with aspects of the inventive concepts.

FIG. 5 is a flow diagram of an embodiment of a method for monitoring a disengagement of a payload by an AMR forklift, in accordance with aspects of the inventive concepts.

FIGS. 6A-6D are top views of the AMR of FIG. 5 in relationship to a pallet and payload at the four distinct positions.

FIGS. 7A and 7B are side views of an AMR in a retracted and extended state, in accordance with aspects of the inventive concepts.

### DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

According to the present inventive concepts, a system is provided in which a mobile robot, e.g., an AMR, is notified and stopped when a payload is not properly and fully engaged or disengaged, e.g., the payload unintentionally pushed or dragged. In doing so, the system uses a sensor that determines one or more positions of the payload relative to the forks of the robot to determine if the payload is being pushed or dragged based on a presence or an absence of the payload at the multiple locations of the forks.

In various embodiments, the system includes at least one additional distance sensor, in particular, in addition to a carriage sensor, which enables monitoring during a reach motion, or during a motion of the vehicle, to assure proper engagement/disengagement of the payload. The system prevents a payload disposed above the ground, such as on a shelf or rack, falling from a height. In some embodiments, the payload presence sensor can be used to adjust safety fields of the vehicle to improve maneuverability.

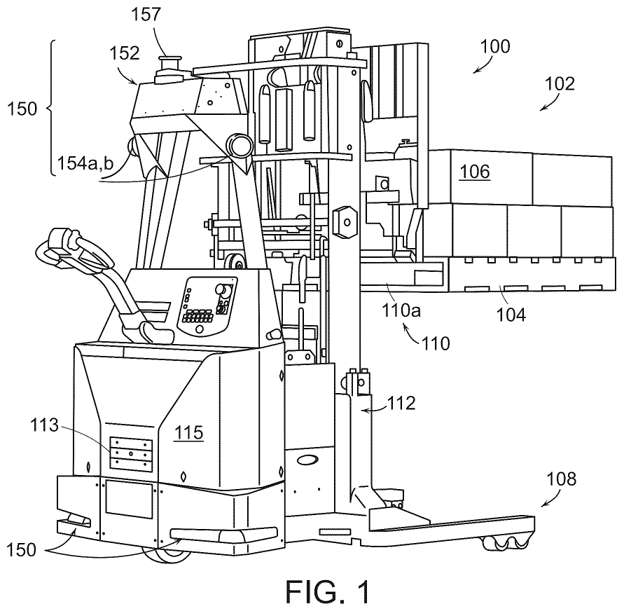

Referring to FIGS. 1A through 1C, collectively referred to as FIG. 1, shown is an example of a self-driving or robotic vehicle 100 in the form of an AMR that can be configured with the sensing, processing, and memory devices and subsystems necessary and/or useful for performing dynamic path adjust in accordance with aspects of the inventive concepts. The robotic vehicle 100 takes the form of an AMR pallet lift, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a pallet 104 loaded with goods, which collectively form a palletized payload 106. To engage and carry the pallet 104, the robotic vehicle may include a pair of forks 110, including a first and second forks 110a,b. Outriggers 108 extend from a chassis 190 of the robotic vehicle in the direction of the forks to stabilize the vehicle, particularly when carrying the palletized load. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a carriage 114 that enable the robotic vehicle 100 to raise and lower and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load. In various embodiments, the robotic vehicle may be configured to robotically control the yaw, pitch, and/or roll of the forks 110 to pick a palletized load in view of the pose of the horizontal surface that is to receive the load.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

The sensors 150 can include one or more stereo cameras 152 and/or other volumetric sensors, sonar sensors, radars, and/or laser imaging, detection, and ranging (LiDAR) scanners or sensors 154 and 154a,b, as examples. Inventive concepts are not limited to particular types of sensors. In various embodiments, sensor data from one or more of the sensors 150, e.g., one or more stereo cameras 152 and/or LiDAR scanners 154a,b, can be used to generate and/or update a 2-dimensional or 3-dimensional model or map of the environment, and sensor data from one or more of the sensors 150 can be used for the determining location of the robotic vehicle 100 within the environment relative to the electronic map of the environment. In the embodiment shown in FIG. 1, at least one of the LiDAR devices 154a,b can be a 2D or 3D LiDAR device. In alternative embodiments, a different number of 2D or 3D LiDAR device are positioned near the top of the robotic vehicle 100. Also, in this embodiment a LiDAR 157 is located at the top of the mast. Some embodiments LiDAR 157 is a 2D LiDAR used for localization.

In some embodiments, the sensors 150 can include sensors configured to detect objects in the payload area and/or behind the forks 110a,b. The sensors can be used in combination with others of the sensors, e.g., stereo camera head 152. In some embodiments, the sensors 150 can include one or more carriage sensors 156 oriented to collected 3D sensor data of the payload area 102 and/or forks 110. The carriage sensors 156 can include a 3D camera and/or a LiDAR scanner, as examples. In some embodiments, the carriage sensors 156 can be coupled to the robotic vehicle 100 so that they move in response to movement of the actuators 111 and/or fork 110. For example, in some embodiments, the carriage sensor 156 can be slidingly coupled to the carriage 114 so that the carriage sensors move in response to up and down and/or extension and retraction movement of the forks. In some embodiments, the carriage sensors collect 3D sensor data as they move with the forks.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

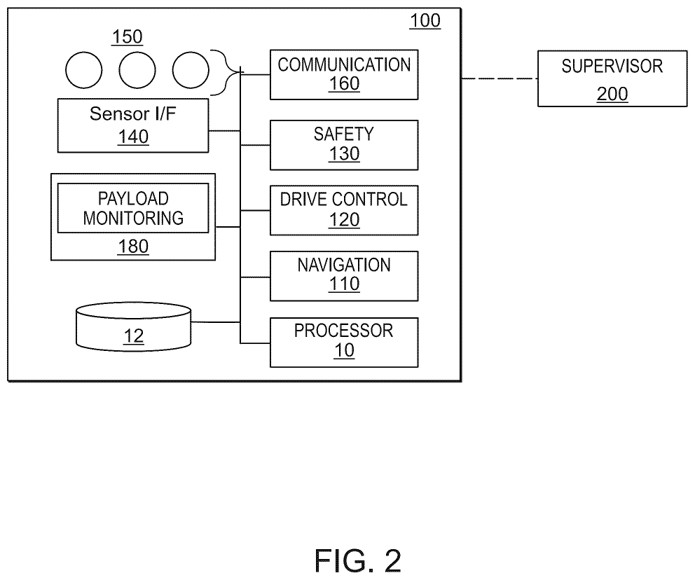

FIG. 2 is a block diagram of components of an embodiment of the robotic vehicle 100 of FIG. 1, incorporating path adaptation technology in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “Supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with the supervisor 200 and any other external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. The path may be stored for future use and may be updated, for example, to include more, less, or different locations, or to otherwise revise the path and/or path segments, as examples.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as the electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 170 configured to access environmental data, such as the electronic map, and path information stored in memory 12, as examples. The navigation module 170 can communicate instructions to a drive control subsystem 120 to cause the robotic vehicle 100 to navigate its path within the environment. During vehicle travel, the navigation module 170 may receive information from one or more sensors 150, via a sensor interface (I/F) 140, to control and adjust the navigation of the robotic vehicle. For example, the sensors 150 may provide sensor data to the navigation module 170 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

In various embodiments, the robotic vehicle 100 can include a payload engagement module 185. The payload engagement module 185 can process sensor data from one or more of the sensors 150, such as carriage sensors 156, and generate signals to control one or more actuators that control the engagement portion of the robotic vehicle 100. For example, the payload engagement module 185 can be configured to robotically control the actuators 111 and carriage 114 to pick and drop payloads. In some embodiments, the payload engagement module 185 can be configured to control and/or adjust the pitch, yaw, and roll of the load engagement portion of the robotic vehicle 110, e.g., forks 110.

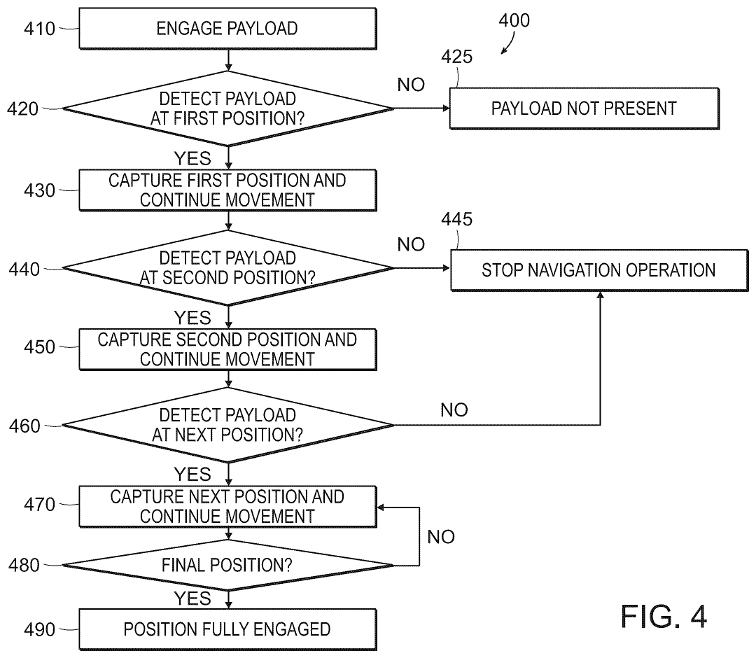

In example embodiments, the robotic vehicle 100 may use and/or include a payload monitoring module 180 that executes program code stored in the memory 12 for perform its operations and tasks, including those related to position-related signals received by the carriage sensor 156, for example, storing and executing program code corresponding to some or all of the steps of method 400 described with reference to FIG. 4.

In some embodiments, a carriage sensor 156 can be mounted to a payload engagement structure of the lift mast 118 to which the backrest 116 or carriage 114, or other AMR component is movably attached that allows the sensor 156 to move vertically with the forks 110, i.e., pair of forks (or tines), that engage and disengage from a palletized load, or payload. In some embodiments, the carriage sensor 156 can be another example of a sensor 150, e.g., carriage sensor 156 of FIGS. 1A-2. In some embodiments, the carriage sensor 156 is a 2D LiDAR sensor that provides PLd field occlusion detection. In preferred embodiments, the carriage sensor 156 is mounted to the vehicle 100 so that it is positioned to determine the presence or absence of a payload relative to the forks 110. The payload engagement structure can include the mast 118 to which the load backrest 116, carriage 114, and forks 110 are movably attached, so that the load backrest 116, carriage 114, and forks 110 can move up and down vertically to engage (pick), carry, and disengage from (drop off) the payload 106. In various embodiments, the sensor 156 is not mounted between the forks 110, but at other locations on the vehicle 100 to sense a presence of objects between the forks 110. In preferred embodiments, the carriage sensor 156 is mounted such that during use there is a direct visible path between the carriage sensor 156 and the forks 110 in the absence of a pallet or payload 106.

In various embodiments, the carriage sensor 156 could include a single laser scanner alone or in combination with other sensors. In various embodiments, the carriage sensor 156 could include a plurality of laser scanners, whether 2D or 3D. In various embodiments, the payload scanner can include one or more sensors and/or scanners configured to sense the presence or absence of an object and/or an edge of an object.

In various embodiments, the carriage sensor 156 (or scanner) can be configured to look for the leading edge of an object. The carriage sensor 156 can be between outriggers 108 but not limited thereto. The carriage sensor 156 can be configured to give a distance measurement for continuous estimation of the payload position relative to the forks or it can be configured to give a set of discrete outputs at specified distances along the forks to know the region of engagement of the payload 106 by the forks 110.

According to various embodiments, the carriage sensor 156 can take the form or include a safety laser scanner oriented and configured to detect a payload at multiple different discrete locations along the forks 110. In other embodiments, the carriage sensor 156 utilized is not limited to a laser scanner. Alternate configurations could utilize different sensing technology (for example, pressure, capacitive, and/or other types of sensors) to sense payload location and/or presence relative to the folks of a robotic vehicle 100, in particular, an AMR forklift. This can be accomplished using single or multiple sensors 150. It can also be accomplished with binary sensor outputs or distance measurement outputs. For example, another sensor may rely on a string encoder to report the position of the pantograph mast when the reach motion is activated. During motion of the vehicle, an incremental encoder is used to report motion of the AMR. However, the sensors are not limited to an encoder and can be any type of distance sensor. In some embodiments, a reach encoder (not shown) is near the backrest 116. In some embodiments, a motion encoder (not shown) is located under the main housing 115 of the vehicle 100.

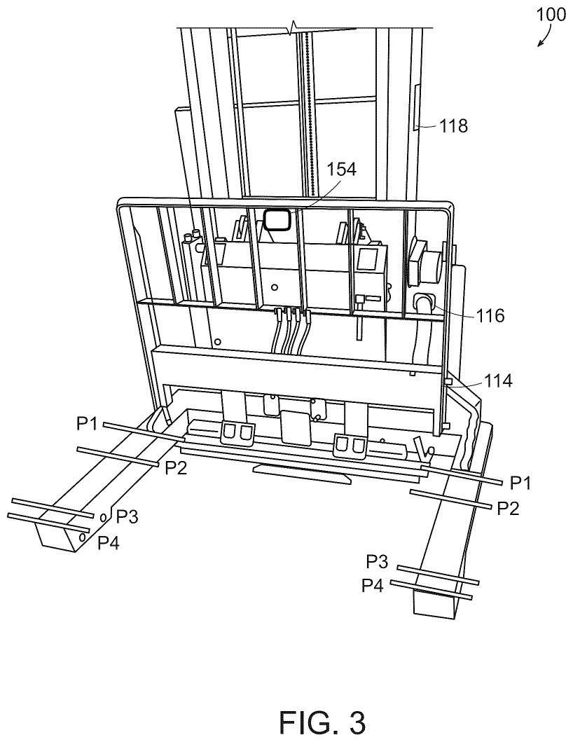

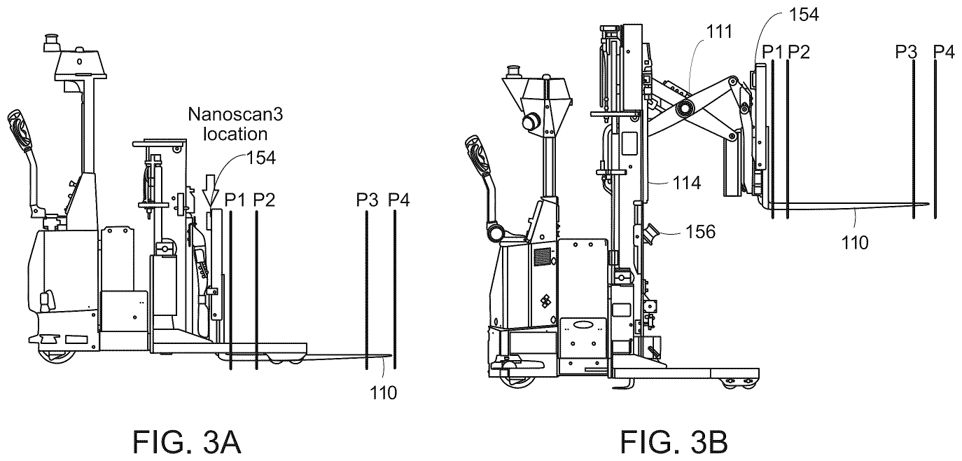

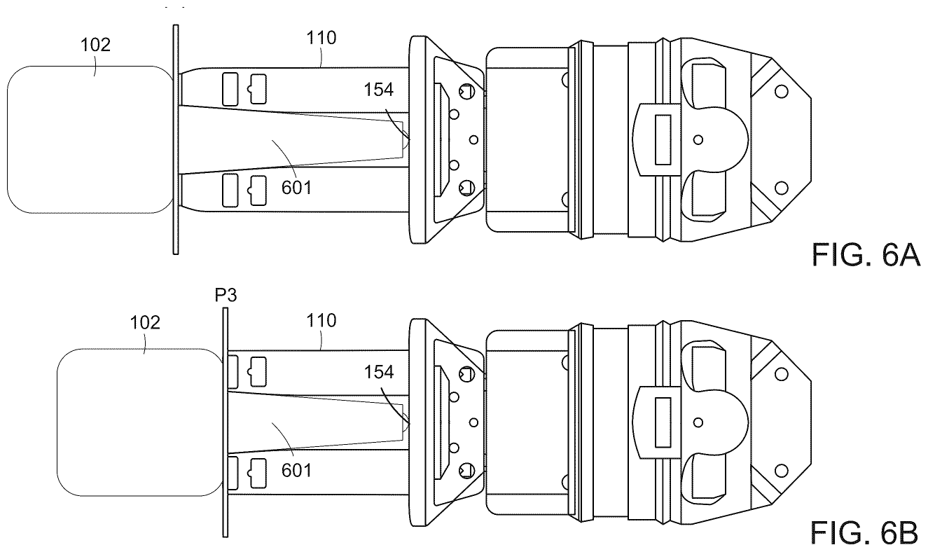

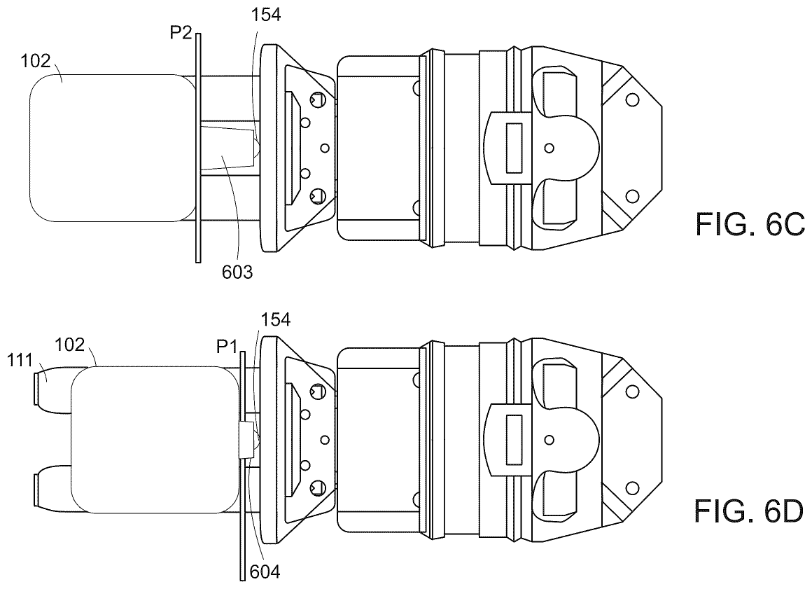

FIG. 4 illustrates an example embodiment of a payload monitoring method 400 that can be executed by the payload monitoring module 180 of FIGS. 1-3. As shown in FIGS. 4 and 6A-6D, in some embodiments, the multiple locations along a length of the forks 110 can include four locations (P1, P2, P3, P4) on the forks 110. In other embodiments, the multiple locations can include more or less than four locations on the forks 110.

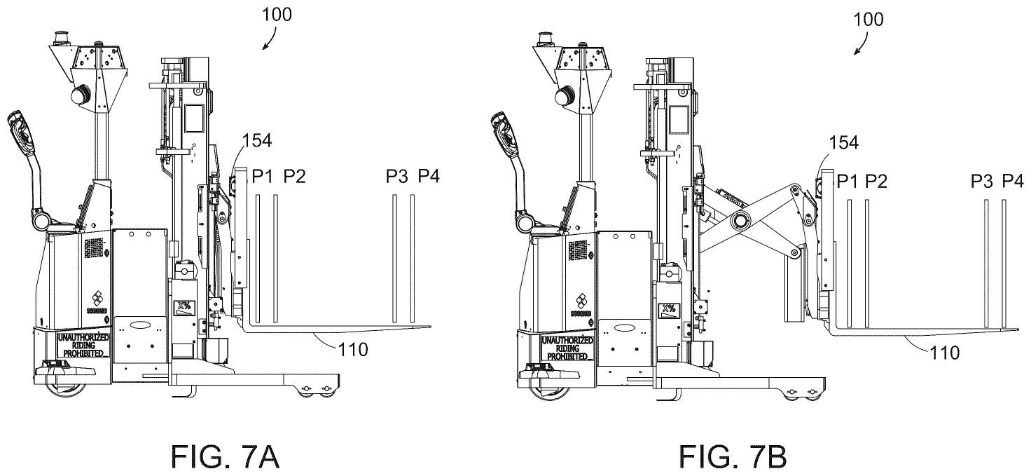

In step 410, the AMR lift 100 is either driven to engage the payload 106 including a pallet 104 loaded with goods 106 or the AMR's forks 110 are extended to reach and engage the payload 106. For example, the forks 110 can extend in a reach motion along a reach axis, for example, shown in FIGS. 7A and 7B, where the pantograph extends the backrest 114 and forks 110. The payload 106 may be on a pallet 104 at ground level, or at a height (FIGS. 7A and 7B) requiring the forks 110 to be raised along the lift mast 118 to a height permitting the forks 110 to extend through openings in the pallet, for example, on a shelf at the height. The sensor 154 can be activated upon the start of motion of the AMR lift 100, or more specifically, its forks 110, through the pallet 104. In decision diamond 420, a determination is made a payload is present at a distalmost position P4, also referred to as a first position. In particular, the sensor 154 outputs a signal 601 to detect objects between the two forks 110 at the first position P4, for example, shown in FIG. 6A. More specifically, the position monitoring module 180 monitors a position of the leading pallet edge relative to the backrest 114 throughout the engagement process. If yes, then in step 430, the position of either the reach axis or AMR lift 100 is captured by the payload monitoring module 180. If no, then in step 425, the payload monitoring module 180 determines that a payload 106 is not present.

Also, in step 430, the AMR lift 100 continue to engage the payload 106 until it engages the distance between the first sensor detection position P4 and a second position P3. Detection of the payload 106 by the sensor 154 outputting a signal 602 to the second position P3, for example, shown at FIG. 6B, validates that the payload 15 is being properly engaged and not pushed by the forks 110. In decision diamond 440, if a determination is made that the forks 110 do not progress movement in the pallet 104 so that the payload moves from the first position P4 to the second position P3, then this is an indication that the payload 106 is being pushed or dragged, and the method 400 proceeds to step 445, where the payload monitoring module 180 generates a signal for use by a drive system of the robot 100 to stop, pause, or alter navigation based on the determination of the payload being pushed or dragged. Otherwise, the method 400 proceeds to step 450, where during payload engagement the payload position relative to the forks 110 can be continued to be detected until the payload edge moves from the second position P3 to a next position, e.g., third position P2, which indicates that the payload engagement continues.

The payload position relative to the forks 110 can be continued to be detected until the payload edge moves from the second position P3 to a third position P2, for example, by the sensor 154 outputting a signal 603 to the second position P2, fore example, shown in FIG. 6C. In decision diamond 460, a determination can be made during payload engagement that the forks 110 engage the payload 106 at the third position P2, followed by step 470 where during payload engagement the payload position relative to the forks 110 can be continue movement through the pallet 104 under the payload 106. If the forks 110 do not engage the third position P2, then the method 400 proceeds to step 445, where the payload monitoring module 180 generates a signal for use by a drive system of the robot 100 to stop, pause, or alter navigation based on the determination of the payload not proceeding to the third position P2.

Steps 460 and 470 can be repeated when the robot progresses from the third position P2 to the fourth position P1, for example, shown in FIG. 6D. At decision diamond 480, a determination is made whether the payload 106 has moved to the final position P1, and if so, the method 400 proceeds to step 490 where the payload is fully engaged by the forks 110. For example, as shown in FIG. 6D, the sensor 154 outputs a signal 604 to the payload 106 at the fourth and final position P1.

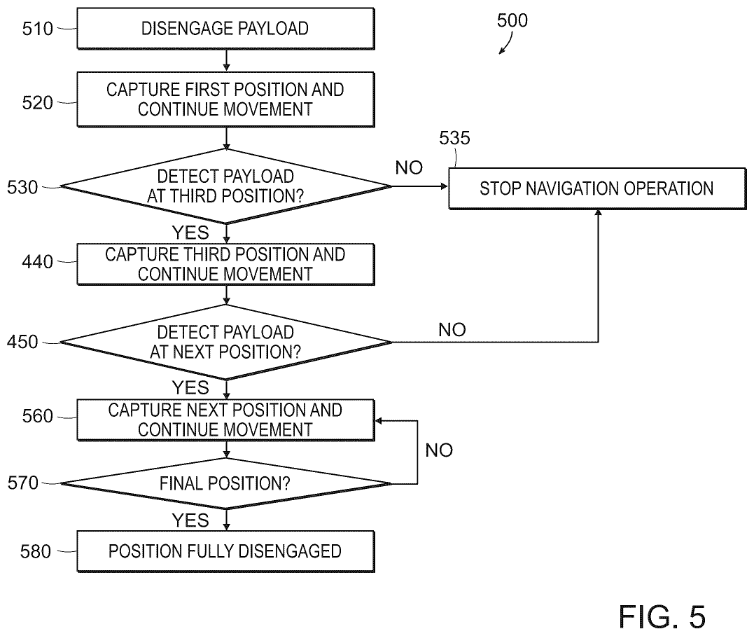

FIG. 5 is a flow diagram of an embodiment of a method 500 for monitoring a disengagement of a payload by an AMR forklift, in accordance with aspects of the inventive concepts. The payload monitoring method 500 can be executed by the payload monitoring module 180 of FIGS. 1-3. Similar to the engagement process of FIG. 4, the position monitoring module 180 monitors a position of the leading pallet edge relative to the backrest 114 throughout the disengagement process.

In step 510, the AMR lift 100 travels to disengage or drop off a pallet 104 loaded with goods 106, or payload 106. In step 520, as the AMR lift 100 disengages the payload, the payload monitoring module 180 determines from the sensor data no presence of the payload 106 at the fourth sensor position P1, and continues to monitor the payload as it moves from the fourth position P1 to the third position P2 relative to the forks 110.

In decision diamond 530, if the carriage sensor 156 no longer detects the payload 106 at the third position P2, this validates that the payload 15 is being properly disengaged. In decision diamond 530, if a determination is made that the sensor 154 detects the payload 106 at position P2, this indicates that the payload 106 is being dragged instead of properly disengaged or properly placed at the location for dropping off the payload 106 and the method 500 proceeds to step 535, where the payload monitoring module 180 generates a signal for use by a drive system of the robot 100 to stop, pause, or alter navigation or subsequent movement of the AMR lift 100. Otherwise, the method 500 proceeds to step 540, where during payload disengagement, the payload position relative to the forks 110 can be continued to be detected until the payload edge moves from the third position P2 to the second position P3, where the carriage sensor 156 continues to detect the fork 110 indicating that the payload is no longer over the third position P3 and that the payload disengagement continues.

In decision diamond 550, a determination can be made during payload disengagement whether the payload 106 is at the next position P2. If the sensor 154 detects the payload 106 at the second position P3, then the method 400 proceeds to step 535, where the payload monitoring module 180 generates a signal for use by a drive system of the robot 100 to stop, pause, or alter navigation. Otherwise, the method 500 proceeds to step 560, where during payload disengagement continues and the payload 106 from the second position P3 to the fourth position P4. Steps 550 and 560 can be repeated when the robot progresses from the second position P3 to the first position P4. At decision diamond 570, a determination is made whether the payload 106 has moved to the final disengagement position P4, and if so, the method 500 proceeds to where in step 580 the payload is fully disengaged by the forks 110.

According to various embodiments of the present inventive concepts, the system provides both performance level—d (PL-d) (per ISO-13849-1) multi-stage discrete and performance level -a (PL-a) continuous measurement of fork tine engagement into pallet pockets. The system includes a mobile robotics platform, such as an AMR, with fork tines and a backrest, at least one sensor, for example, a 2D LiDAR sensor that has PL-d field occlusion detection as well as raw data output, an algorithm for parsing raw data into the nearest pallet point (alternatively, the nearest point of the payload, the pallet itself, or any arbitrary point at a set height of the payload) and calculating its proximity to the backrest, and a local computer for processing. In some embodiments, some or all of the algorithm is implemented as program code in a memory and executed by at least one computer processor of the payload monitoring module 180 described herein. LiDAR refers to light detection and ranging or laser imaging, detection, and ranging, as an example of a ranging and detection system.

During engaging or disengaging a payload, the system continuously monitors the position of the leading pallet edge relative to the backrest. The method of operating the system includes checking both the discrete and continuous measurements in conjunction with odometry of the AMR, using this information to determine whether a payload is moving appropriately with respect to AMR motion, and detecting cases where the payload may not be engaging or disengaging correctly.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. An autonomous mobile robot, comprising:
a payload engagement portion comprising a pair of fork tines in a payload engagement area;
at least one processor in communication with at least one computer memory device; and
a payload monitoring system comprising:
at least one sensor arranged between the fork tines to acquire position data in and beyond the payload engagement area; and
a computer program code executable by the at least one processor to process the position data to determine a position of a payload relative to the fork tines .

2. The robot of claim 1, wherein the payload monitoring system is further configured to provide continuous estimation of the payload position relative to fork tines.

3. The robot of claim 1, wherein the payload monitoring system is further configured to determine if the payload is being picked up or dropped off based on the position data.

4. The robot of claim 1, wherein the payload monitoring system is further configured to generate a signal for use by a drive system of the robot to stop, pause, or alter navigation based on a determination by the payload monitoring system that the payload is being pushed or dragged.

5. The robot of claim 1, wherein the at least one sensor comprises a 2D LiDAR sensor that has PLd field occlusion detection and raw data output.

6. The robot of claim 1, wherein the at least one carriage sensor comprises a laser scanner.

7. (canceled)

8. The robot of claim 1, wherein the at least one sensor is configured to monitor a leading edge of a payload along the fork tines.

9. The robot of claim 1, wherein the at least one sensor is positioned to have a line of sight with the fork tines of the robot.

10. The robot of claim 1, wherein the fork tines are at an elevation and along a reach axis, and the at least one sensor acquires position data indicating a position of the payload relative to the fork tines along the reach axis.

11. A method of monitoring a payload by an autonomous mobile robot, the robot comprising a payload engagement portion comprising a pair of fork tines in a payload engagement area, the method comprising:
disposing at least one sensor between the fork tines;
the at least one sensor acquiring position data in and beyond the payload engagement area; and
computer processing the position data to determine a position of a payload relative to the fork tines.

12. The method of claim 11, further including providing continuous estimation of the payload position relative to the fork tines.

13. The method of claim 11, further comprising determining if the payload is being picked up or dropped off based on the position data.

14. The method of claim 11, further comprising generating a signal for use by a drive system of the robot to stop, pause, or alter navigation based on a determination of the payload being pushed or dragged.

15. The method of claim 11, wherein the at least one sensor comprises a 2D LiDAR sensor that has PLd field occlusion detection and raw data output.

16. The method of claim 11, wherein the at least one sensor comprises a laser scanner.

17. (canceled)

18. The method of claim 11, further comprising the at least one sensor monitoring a leading edge of the payload relative to the fork tines.

19. The method of claim 11, wherein the at least one sensor is arranged in a line-of-sight the fork tines of the robot.

20. The method of claim 11, wherein the fork tines are at an elevation and along a reach axis, and the method includes processing the position data to determine a position of the payload relative to the fork tines along the reach axis.

21. The method of claim 11, wherein determining the location of the payload relative to the fork tines further comprising providing a set of discrete outputs at specified distances along the fork tines.

22. The robot of claim 1, wherein the payload monitoring system is further configured to provide a set of discrete outputs at specified distances along the fork tines to determine the location of the payload relative to the fork tines.
